(19) United States
(12) Patent Application Publication
(10) Pub. No.: US 2026/0246637 A1
(43) Pub. Date: Aug. 20, 2026

(54) Enhancements to e-SIM Transfer Operations

(71) Applicant: Apple Inc., Cupertino, CA (US)

(72) Inventors: Li LI, Saratoga, CA (US); Aurelien P RABOISSON, San Diego, CA (US); Hyewon LEE, Cupertino, CA (US); Jean-Marc PADOVA, San Francisco, CA (US); Ngabin S NG, San Diego, CA (US); Xiangying YANG, Cupertino, CA (US)

(21) Appl. No.: 19/160,897

(22) PCT Filed: Mar. 8, 2024
(86) PCT No.: PCT/US2024/019187

§ 371 Date: Aug. 29, 2025

Related U.S. Application Data
(60) Provisional application No. 63/489,572, filed on Mar. 10, 2023.

(51) Int. Cl. H04L 9/32; H04W 8/20; H04W 12/71

(52) U.S. Cl. CPC H04L 9/3213; H04W 8/205; H04W 12/71

(57) ABSTRACT

An apparatus configured to process, based on signaling received from a user equipment (UE), a request to export a selected embedded subscriber identity module (e-SIM) profile, the request comprising an integrated circuit card identification (ICCID) corresponding to the selected e-SIM profile and a target cryptographic token corresponding to the ICCID, determine the e-SIM profile corresponding to the ICCID is stored on the apparatus and is eligible for export, generate a transaction identification (TID) corresponding to the ICCID and a source cryptographic token corresponding to the ICCID and generate, for transmission to the UE, a source encrypted signature comprising the ICCID, the TID, the source cryptographic token and the target cryptographic token.

### BACKGROUND

The adoption of embedded-subscriber identity modules (e-SIM) in user equipment (UE) has brought several user experience issues. While physical SIM cards (e.g., micro-SIM, nano-SIM) may be physically swapped between a first UE and a second UE, no such equivalent action may be taken with an e-SIM. Use of one or more embedded universal integrated circuit cards (eUICCs) is necessary to exchange subscriber identity information between two UEs. Existing implementations of e-SIM transfer leave room for improvement to the user experience.

### SUMMARY

Some example embodiments are related to an apparatus having processing circuitry configured to process, based on signaling received from a user equipment (UE), a request to export a embedded subscriber identity module (e-SIM) profile, the request comprising an integrated circuit card identification (ICCID) corresponding to the e-SIM profile and a target cryptographic token corresponding to the ICCID, determine the e-SIM profile corresponding to the ICCID is stored on the apparatus and is eligible for export, generate a transaction identification (TID) corresponding to the ICCID and a source cryptographic token corresponding to the ICCID and generate, for transmission to the UE, a source encrypted signature comprising the ICCID, the TID, the source cryptographic token and the target cryptographic token.

Other example embodiments are related to an apparatus having processing circuitry configured to generate, for sending to a user equipment (UE), a request to export a embedded subscriber identity module (e-SIM) profile, the request comprising an integrated circuit card identification (ICCID) corresponding to the e-SIM profile and a target cryptographic token corresponding to the ICCID, process, based on signals received from the second UE, a source encrypted signature comprising the ICCID, a transaction identification (TID) corresponding to the ICCID, a source cryptographic token corresponding to the ICCID and the target cryptographic token, verify the source encrypted signature based on at least the ICCID and the target cryptographic token and generate, for transmission to the UE, a target encrypted signature comprising the ICCID, the TID, and the source cryptographic token.

Still further example embodiments are related to an apparatus having processing circuitry configured to process, based on signals received from a user equipment (UE), a request to export a embedded subscriber identity module (e-SIM) profile, the request comprising an integrated circuit card identification (ICCID) corresponding to the e-SIM profile, determine the e-SIM profile corresponding to the ICCID is stored on the apparatus and is eligible for export, generate a source cryptographic token corresponding to the ICCID, generate, for transmission to the UE, a message comprising the source cryptographic token, process, based on signals received from the UE, a target encrypted signature comprising the ICCID, the source cryptographic token and a target cryptographic token corresponding to the ICCID and verify the target encrypted signature based on at least the ICCID and the source cryptographic token.

Additional example embodiments are related to an apparatus having processing circuitry configured to generate, for transmission to a user equipment (UE), a request to export a embedded subscriber identity module (e-SIM) profile, the request comprising an integrated circuit card identification (ICCID) corresponding to the e-SIM profile, process, based on signals received from the UE, a message comprising a source cryptographic token, generate a target cryptographic token corresponding to the ICCID, and generate, for transmission to the UE, a target encrypted signature comprising the ICCID, the source cryptographic token and the target cryptographic token.

Additional example embodiments are related to a method performed by an embedded universal integrated circuit card (eUICC) of a user equipment (UE). The method includes receiving, from an extended storage component of the UE, a request to export a embedded subscriber identity module (e-SIM) profile, the request comprising an integrated circuit card identification (ICCID) corresponding to the e-SIM profile, determining the e-SIM profile corresponding to the ICCID is stored on the eUICC, the e-SIM profile is eligible for export and the e-SIM profile is disabled, generating a transaction identification (TID) corresponding to the ICCID, generating a bound profile package (BPP) associated with the e-SIM profile and exporting the BPP associated with the e-SIM profile to the extended storage component

### BRIEF DESCRIPTION OF THE DRAWINGS

FIG. 1 shows an example network arrangement according to various example embodiments.

FIG. 2 shows an example UE according to various example embodiments.

FIG. 3 shows a first state diagram according to various example embodiments.

FIG. 4 shows a second state diagram according to various example embodiments.

FIG. 5 shows a call flow for extended storage to eUICC operations according to various example embodiments.

FIG. 6 shows a call flow for source-first e-SIM transfer according to various example embodiments.

FIGS. 7A-C show a call flow for target-first e-SIM transfer according to various example embodiments.

### DETAILED DESCRIPTION

The example embodiments may be further understood with reference to the following description and the related appended drawings, wherein like elements are provided with the same reference numerals. The example embodiments relate to improvements to UE e-SIM transfer operations.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol, or any other type of network.

The example embodiments are also described with reference to various call flows. These call flows are described with reference to various messages that are exchanged between components and/or devices. The names of the messages in the description are only example and messages that perform the same functionality may be referred to by different names.

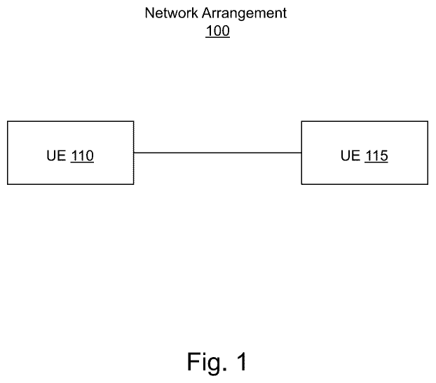

e-SIM technology continues to proliferate in UEs globally. As traditional physical SIM cards are phased out, users will inevitably be faced with situations where it is necessary to transfer an e-SIM between UEs (e.g., upgrading a device). Unlike a physical SIM card, software and signaling may be used to transfer an e-SIM. The example embodiments are directed to improved methods of e-SIM transfer. The example embodiments relate to UE to UE operations, without the direction of a network (e.g., a 5G network). Further description of the networking arrangement will be provided with respect to FIG. 1.

Transfer of an e-SIM is a sensitive operation. Absent proper security controls, an attacker may gain access to user data during the transfer process. Requiring physical actions of a user on both sides of the transfer (e.g., double clicking a button on one or more UEs) may mitigate the risk of zero-click attacks. Following the double click, an eUICC may be signed by a UE. While double clicking is mentioned here, it is apparent that other actions are also possible (e.g., triple clicking, click and hold for a specified time, etc.) .

The example embodiments minimize impact on carrier networks because the example embodiments are entirely UE to UE, with no direction from the network. eUICC capabilities may be exchanged between UEs, allowing for different operations based on a source UE capability and a target UE capability (e.g., different generations of UE).

The example embodiments further relate to local export operations. Local export operations may be between a UE eUICC and a UE extended storage. Such embodiments may be used for example, in situations such as a firmware update. During an eUICC firmware update, eUICC data can be exported to the extended storage to free memory in the eUICC during the firmware update. Upon completion of the firmware update, the eUICC may reinstall the exported data from the extended storage. A similar logic may be applied to operations between the eUICC and off-site storage (e.g., cloud storage). Cloud storage of eUICC data may be protected via a passcode, pass key, or any other secure form of data security.

FIG. 1 shows an example network arrangement 100 according to various example embodiments. Network arrangement 100 features UE 110 and UE 115. The UE 110 and the UE 115 may be any type of electronic component that is configured to communicate via a network, e.g., mobile phones, tablet computers, desktop computers, smartphones, phablets, embedded devices, wearables, Internet of Things (IOT) devices, etc. The UEs 110 and 115 may be equivalently capable devices, but they need not be. In other words, the UE 110 could feature additional capabilities compared to the UE 115 in some scenarios to be described below.

The UE 110 and the UE 115 are connected perform an e-SIM transfer. The connection may be a short-range connection such as Bluetooth, Near Field Communication (NFC), wired connection, or a Wireless Local Area Network (WLAN). The UEs 110 and 115 may also be connected via a long-range connection via WLAN or a cellular network (e.g., 5G). Long-range connections such as 5G may serve as connections for the example call flows to be described below. In other words, long-range connections may facilitate the communication between the UEs 110 and 115 but are not integral to the process or operations of e-SIM transfer.

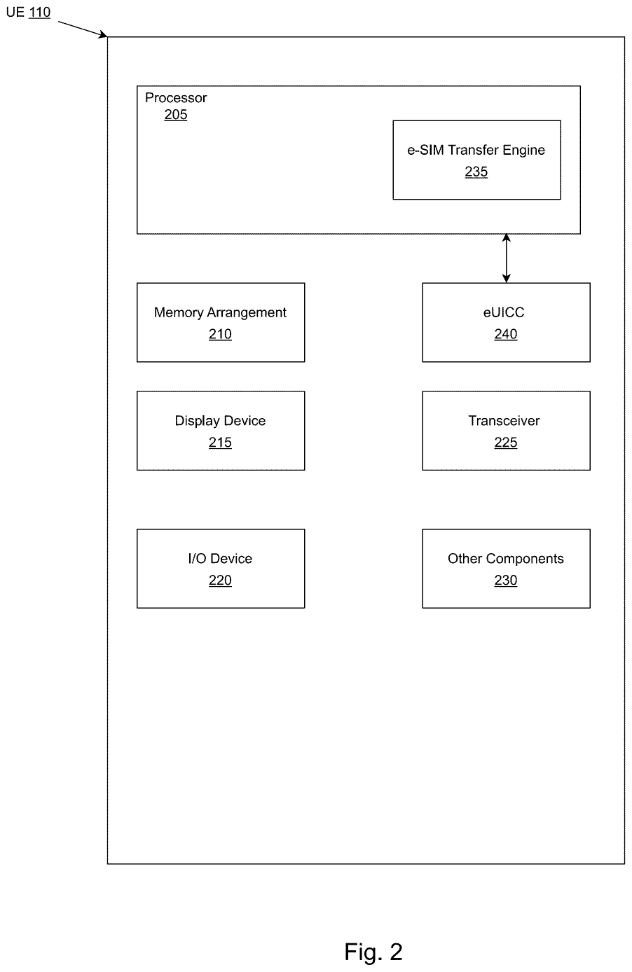

FIG. 2 shows an example UE 110 according to various example embodiments. The description related to UE 110 may equally apply to the UE 115. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. The UE 110 may also feature an eUICC 240. The eUICC 240 may be a hardware component embedded into the UE 110 configured to store a number of carrier profiles.

The processor 205 may be configured to execute a plurality of engines for the UE 110. For example, the engines may include an e-SIM transfer engine 235 for performing operations related to transferring an e-SIM from a first UE (e.g., UE 110) to a second UE (e.g., UE 115), and for operations of moving eUICC data to and from UE extended storage.

The above referenced engine being an application (e.g., a program) executed by the processor 205 is only example. The functionality associated with the engines may also be represented as a separate incorporated component of the UE 110 or may be a modular component coupled to the UE 110, e. g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

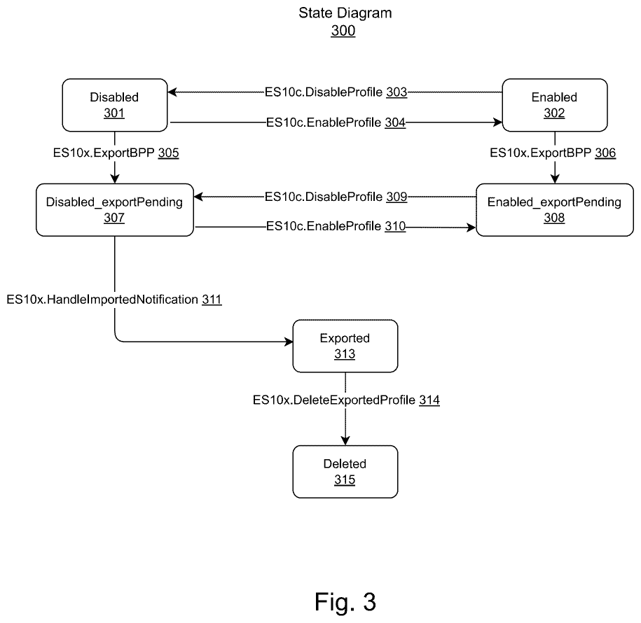

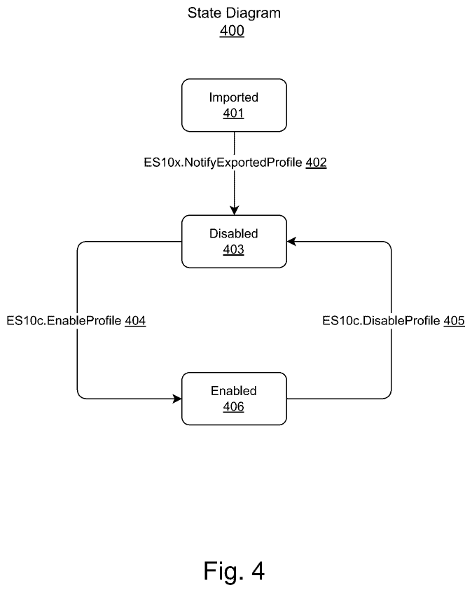

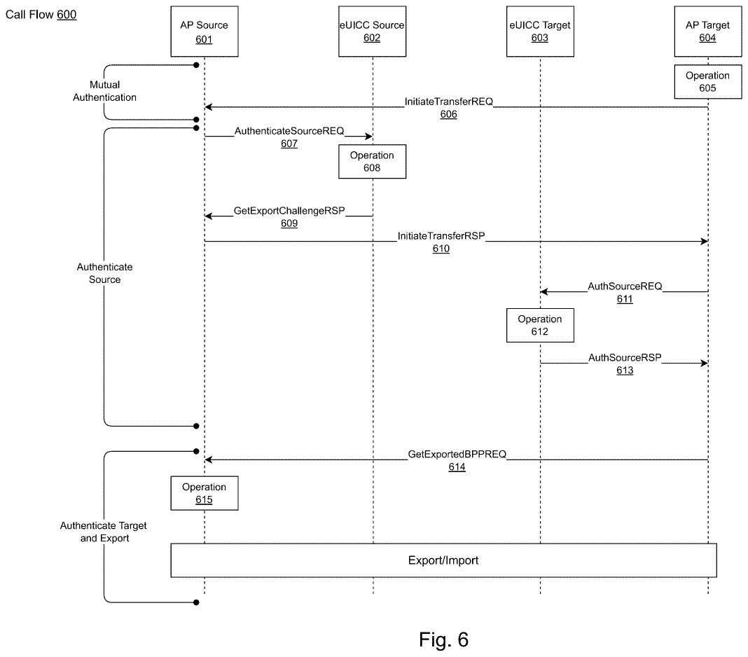

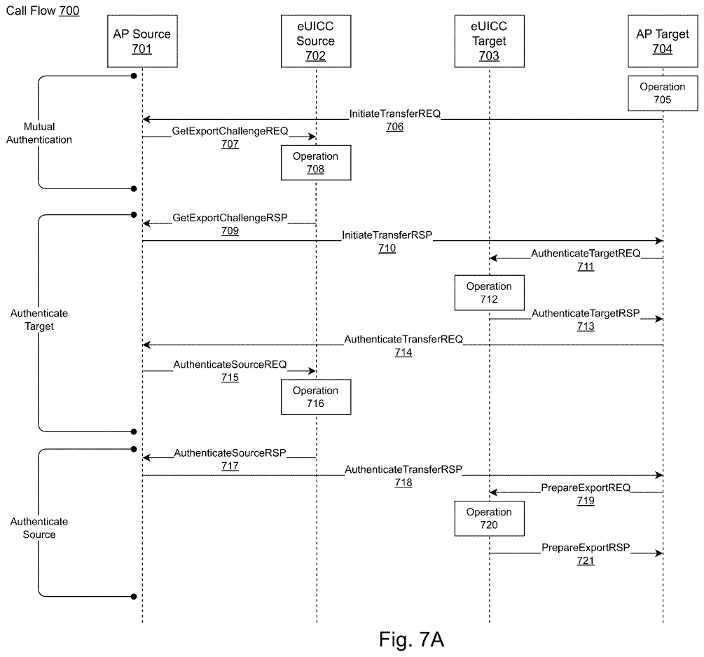

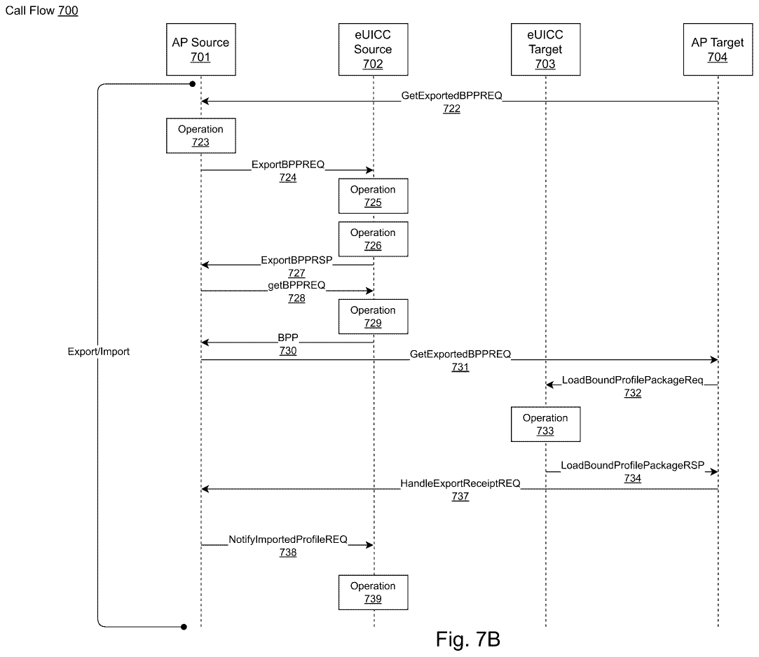

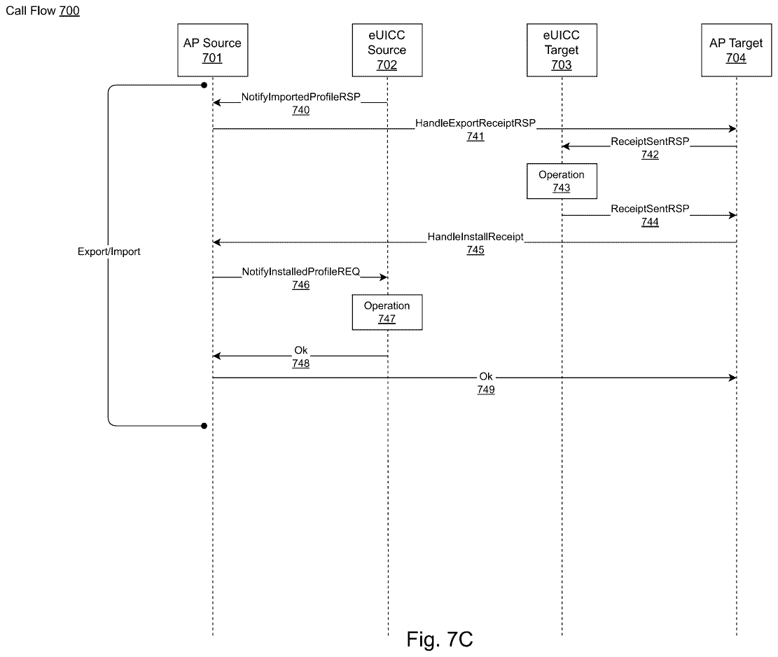

In a first aspect of the example embodiments, call flow logic for e-SIM transfer is disclosed herein. It should be noted that “response” is abbreviated to RSP and “request” is abbreviated to REQ throughout the call flows of the example embodiments. FIGS. 3 and 4 show state diagrams of a profile related to a source device and a target device, respectively, and discussion of the different states will be interspersed into the description of FIGS. 6 and 7.

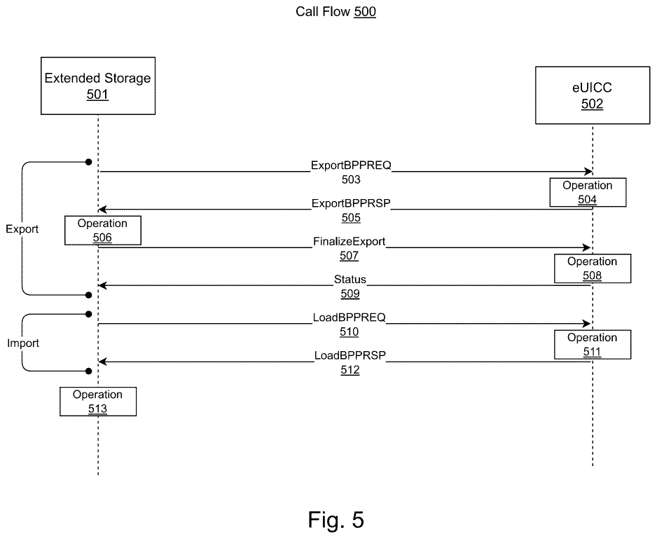

FIG. 5 shows a call flow 500 for extended storage to eUICC operations according to various example embodiments. The extended storage 501 may be embedded storage of an application processor (AP). The eUICC 502 is an eUICC of a UE (e.g., the eUICC 240 of UE 110). Thus, the call flow 500 occurs within a UE. A general purpose of the call flow 500 may be to remove profiles (e.g., one or more profiles that are not currently being used) from the eUICC 502 to free memory of the eUICC 502. In this example embodiment, the one or more profiles may then be stored locally at the UE (e.g., extended storage 501 of the AP). The one or more profiles may then be re-installed on the eUICC 502 as needed using a local process.

As shown in FIG. 5, the first set of operations 503-509 of the call flow are related to an export process. In this context, export refers to exporting a profile from the eUICC 502 to the extended storage 501. The export process may be initiated by the AP (e.g., processor 205 of the UE 110) based on various information that is known by the AP, e.g., the usage of the one or more profiles currently stored on the eUICC, the amount of storage remaining on the eUICC, updating of the operating system of the eUICC 502, etc. To provide some example use cases, the eUICC 502 has a limited amount of storage and a UE may have multiple profiles. Thus, moving profiles to extended storage 501 may free some of the limited storage of the eUICC 502. In another use case, the operating system of the eUICC 502 may need to be updated. This updating is a complex process and could corrupt some of the information in one or more profiles. Thus, the profiles may be exported from the eUICC 502, which may then update the operating system and then the profiles may be reinstalled after the update of the eUICC 502 is completed. In another example use case, the UE may be completely wiped, but exporting the profiles to the extended storage 501 may be used for backup purposes.

In 503, the extended storage 501 sends an ExportBPPREQ (Export Bound Profile Package Request) message with a mode set to internal and an Integrated Circuit Card Identification (ICCID) identifying an individual profile to the eUICC 502.

In operation 504, the eUICC 502 verifies that the ICCID exists (e.g., the ICCID in the message matches an ICCID of a profile stored in the eUICC), checks that the profile is disabled (e.g., enabled profiles are not eligible for export), checks that the profile is exportable (e.g., profiles may be defined as exportable or not exportable, for example, in the metadata of the profile), generates a transaction ID (TID) and a link to the profile, generates and stores one or more session keys (e.g., to be used at a later time if the profile is to be reinstalled on the eUICC 502), and transitions a profile state to “EXTENDED STORAGE” (e.g., from the disabled state to the extended storage state to indicate the location of the exported profile).

In 505, the eUICC 502 transmits an exported BPPRSP message to the extended storage 501. The message 505 includes a bound profile package (BPP) for the profile to be exported. The BPP may include profile elements such as a file system, applications data, etc. In some examples, the BPP may include the standardized profile elements such as those defined by GSMA but there is no requirement that the BPP include standardized profile elements. The BPP may also be encrypted and bound to the eUICC 502 (e.g., the profile will not be able to be imported to a different eUICC). The message 505 may also include the generated session keys from operation 504.

In operation 506, the extended storage 501 stores the exported BPP. In 507, the extended storage 501 transmits a FinalizedExport message to the eUICC 502 including the ICCID and indicating that the storage operation 506 was performed successfully. In operation 508, the eUICC 502 removes the profile from its internal storage. In 509, the eUICC 502 transmits a status message to the extended storage 501 indicating that operation 508 was performed successfully.

The second set of operations 510-513 of the call flow 500 are related to an import process. In this context, import refers to importing a profile stored on the extended storage 501 to the eUICC 502. The import process may be triggered either automatically or manually. For example, the AP may determine that a particular profile that has been exported to the extended storage 501 should be imported back to the eUICC 502 based on any factor, e.g., the AP determines the UE 110 is to perform an operation for which the particular profile is needed. In another example, the user of the UE 110 may select to import the particular profile back to the eUICC 502.

In 510, the extended storage 501 transmits a LoadBPPREQ message including the BPP information to the eUICC 502. In operation 511, the eUICC 502 checks the TID and that the status of the profile is “EXTENDED STORAGE.” If these checks are satisfied, the eUICC 502 re-installs the profile. When the re-installation is successful, the eUICC 502 deletes the TID and session keys and generates an installation receipt. In 512, the eUICC 502 transmits a LoadBPPRSP message to the extended storage 501, including the installation receipt. In operation 513, the extended storage 501 manages the installation receipt (e.g., the installation receipt may be used to confirm to the carrier that the profile has been reinstalled on the eUICC 502) and deletes the BPP.

The following example embodiments illustrate examples of a profile being exported or transferred from a source device (e.g., UE 110) to a target device (e.g., UE 115). In the examples provided below, it will be considered that the UE 110 is the source device and the UE 115 is the target device but this is only example. The call flow of FIG. 6 is related to the source device (e.g., UE 110) initiating the transfer while the call flow of FIGS. 7A-C is related to the target device (e.g., UE 115) initiating the transfer.

FIG. 6 shows a call flow 600 for source-first e-SIM transfer according to various example embodiments. The call flow 600 is performed among the AP and eUICC of the source device UE 110 (e.g., Source AP 701 and source eUICC 702) and the AP and eUICC of the target device UE 115 (e.g., target eUICC 703 and Target AP 704). In this example, the source device (e.g., the UE 110) will initiate the authentication for the transfer of the selected profile. Referring to the state diagram 300 of FIG. 3 for the profile on the source device, it can be seen that a profile in the disabled state 301 or in the enabled state 302 may be eligible for export from the source device. Thus, at the beginning of the call flow 600, the profile to be exported from the source device UE 110 is either in the disabled state 301 or the enabled state 302.

Initially, the set of operations 605-606 are related to mutual authentication of the source device UE 110 and target device UE 115. In operation 605, the Target AP 604 of the UE 115 displays an e-SIM plan to a user, e.g., one or more profiles that may be transferred from the source device UE 110. The user may select a profile (e.g., plan or subscription) associated with an ICCID. The Target AP 604 generates a target nonce (TNonce) associated with the ICCID. A nonce generally refers to a cryptographic token. In an aspect, the cryptographic token may be randomly generated. In 606, the Target AP 604 transmits an InitiateTransferREQ message including the ICCID, TNonce, and target eUICCInfol to the Source AP 601.

The set of operations 607-613 are related to authentication of the source device UE 110. In 607, the Source AP 601 transmits a AuthenticateSourceREQ message to the source eUICC 602, including the ICCID, the TNonce, and TeUICCinfo1 (e.g., terminal equipment UICC information that may include various information about the eUICC).

In operation 608, the source eUICC 602 checks if the ICCID exists and verifies that the profile is exportable. As described above, each profile may have metadata (or other information) associated with the profile. This information may be used to indicate characteristics of the profile. For example, in some instances, a carrier may not want a profile to be exportable and the metadata may indicate that a profile is not exportable. Thus, the source eUICC 602 will check if the profile is exportable. In this example, it may be considered that the profile associated with the ICCID is exportable. The source eUICC 602 will also checks that TeUICCinfol contains the CI associated with the profile (e.g., TSignatureKey), selects a key for the Source AP 601 to sign, generates a transaction ID (TID), generates a source nonce (SNonce), and generates a SSigned1 and a SSignaturel with the ICCID, TID, TNonce, SNonce, and TCIPKIdToUse (e.g., a private key).

In 609, the source eUICC 602 sends a GetExportChallengeRSP message including the SSigned1 and SSignaturel to the Source AP 601. In 610, the Source AP 601 transmits an InitiateTransferRSP message to the Target AP 604, including the SSigned1 and SSignature1. In 611, the Target AP 604 transmits an AuthenticateSourceREQ message including SSigned1 and SSignaturel to the target eUICC 603.

In operation 612, the target eUICC 604 verifies the SSignature1, the TNonce (e.g., the TNonce generated in 605), the ICCID, the TCIPKIDToUse. If the verification is successful, the target eUICC 604 stores the TID in session data and generates a otPKTarget (e.g., a one-time public key) and a otSKTarget (e.g., a one-time private key). The target eUICC 604 then generates a TSigned1 and TSignaturel with the SNonce, ICCID, TID, otPKTarget, TCapabilities, and TCIPKIdToUse. In some example embodiments, the source device UE 110 and the target device UE 115 may have different capabilities. Thus, the source and target devices may exchange capabilities (after being authenticated to each other) for the purposes of the transfer operation.

In 613, the target eUICC 603 sends an AuthenticateSourceRSP message to the Target AP 604 including the TSigned1 and TSignature1. At this point in the call flow 600, the source device UE 110 has been authenticated by the target device UE 115.

The set of operations 614-615 are related to authentication of the target device UE 115. In 614, the Target AP 604 transmits a GetExportedBPPREQ including the TSigned1 and TSignaturel to the Source AP 601. In operation 615, the Source AP 601 performs secure intent verification to obtain the end user consent before exporting the profile from the source device UE 110. Secure intent verification may involve user interaction with a user interface (UI) of the source device UE 110 to indicate that the user intends to initiate the transfer of the profile. The Source AP 601 obtains a signed token (e.g., SEPToken) including the ICCID, the Embedded Identity Document (EID) of the eUICC of the target device UE 115 (EIDTarget), and the TID. At this point in the call flow 600, the target device UE 115 has been authenticated by the source device UE 110.

Following the operation 615, the transfer operation (e.g., export operations by the source device UE 110 and import operations by the target device UE 115) are performed. The import/export operations are not shown in this call flow. However, the import/export operations are described below with respect to operations 722-749 of the call flow 700 of FIG. 7. In some example embodiments, the import/export operations shown on FIG. 6 may be the same as the import/export operations described below.

FIGS. 7A-C show a call flow for target-first e-SIM transfer according to various example embodiments. The Source AP 701, source eUICC 702, target eUICC 703, and Target AP 704 are identical in capability and functionality as the Source AP 601, source eUICC 602, target eUICC 603, and Target AP 604, respectively, as described above. In this example, the target device (e.g., the UE 115) will initiate the transfer of the selected profile. Referring back to the state diagram 300 of FIG. 3 for the profile on the source device, it can be seen that a profile in the disabled state 301 or in the enabled state 302 may be eligible for export from the source device. Thus, at the beginning of the call flow 700, the profile to be exported from the source device UE 110 is either in the disabled state 301 or the enabled state 302.

Initially, the set of operations 705-708 are related to mutual authentication of the source device UE 110 and target device UE 115. In operation 705, the Target AP 704 of the UE 115 displays an e-SIM plan to a user, e. g., one or more profiles that may be transferred from the UE 110. The user may select a profile (e.g., plan or subscription) associated with an ICCID.

In 706 the Target AP 704 transmits an InitiateTransferREQ message to the Source AP 701, including the ICCID that the user wants to transfer to the target device UE 115. In 707, the Source AP 701 transmits a GetExportChallengeREQ message including the ICCID to the source eUICC 702. In operation 708, the source eUICC 702 checks if the ICCID exists, verifies that the profile is exportable, and generates a source nonce (SNonce) and associates it with the ICCID.

The set of operations 709-716 are related to authentication of the target device UE 115. In 709, the source eUICC 702 transmits an ExportChallengeRSP message to the Source AP 701, including both the SNonce and eUICCInfo1. In 710, the Source AP 701 sends an InitiateTransferRSP message to the Target AP 704, including the SNonce and eUICCInfo1. In 711, the Target AP 704 sends an AuthenticateTargetREQ to the target eUICC 703, including the SNonce and eUICCInfo1.

In operation 712, the target eUICC 703 generates a target Nonce (TNonce). The target eUICC 703 also evaluates the different signing keys supported on the source device UE 110 using the source eUICCInfol because the source and target devices will agree on using the same public key infrastructure (PKI) to verify the signatures that will be generated. The target eUICC 703 will then generate a Tsigned1 and Tsignature1 for each of the SNonce, ICCID, and TNonce.

In 713, the target eUICC 703 transmits an AuthenticateTargetRSP to the Target AP 704, including the TSigned1 and TSignature1. In 714, the Target AP 704 transmits an AuthenticateTransferREQ message to the Source AP 701, including both the TSigned1 and the TSignature1. In 715, the Source AP 701 transmits an AuthenticateSourceREQ message to the source eUICC 702, including the TSigned1 and the TSignaturel.

In operation 716, the source eUICC 702 verifies the TSignature1, the SNonce and ICCID (e.g., the SNonce is the one generated in operation 708 for the ICCID). If the verifications are successful, the source eUICC 702 then generates a random transaction ID (TID) and generates a SSigned1 and SSignature1 including the TNonce, ICCID, and TID. At this point in the call flow 700, the target device UE 115 has been authenticated by the source device UE 110.

The set of operations 717-721 are related to authentication of the source device UE 110. In 717, the source eUICC 702 transmits an AuthenticateSourceRSP message to the Source AP 701, including the SSigned1 and SSignature1. In 718, the Source AP 701 transmits an AuthenticateTransferRSP to the Target AP 704 including the SSigned1 and SSignature1. In 719, the Target AP 704 transmits a PrepareExportREQ message to the target eUICC 703 including the SSigned1 and SSignature1.

In operation 720, the target eUICC 703 verifies the SSignature1, the TNonce and ICCID (e.g., the TNonce is the one generated in operation 712 for the ICCID). If successful, the source device UE 110 has been authenticated by the target device UE 115. The target eUICC 703 then associates the transfer operation with the TID, generates an otPKTarget (e.g., a one-time public key) and otSKTarget (e.g., a one-time private key) to be associated with the export operation. The target eUICC 703 then generates a TSigned2 and TSignature2 including the otPKTarget, SSigned1, TID, and TargetCapabilites (TCapabilites). In some example embodiments, the source device UE 110 and the target device UE 115 may have different capabilities. Thus, the source and target devices may exchange capabilities (after being authenticated to each other) for the purposes of the transfer operation. In 721, the target eUICC 703 transmits a PrepareExportRSP message to Target AP 704 including the TSigned2 and TSignature2.

The call flow 700 is continued in FIGS. 7B and 7C. The operations 722-749 shown in FIGS. 7B and 7C are related to the transfer operation, e.g., the export operation performed by the source device UE 110 and the import operations performed by the target device UE 115.

In 722, the Target AP 704 transmits a GetExportedBPPREQ including the TSignature2 and TSigned2 to the Source AP 701. In operation 723, the Source AP 701 performs secure intent verification with SEP, and obtains a signed token (SEPToken), including the ICCID, EIDTarget and TID. Secure intent verification may involve user interaction with a user interface (UI) of the source device UE 110 to indicate that the user intends to initiate the transfer of the profile.

In 724, the Source AP 701 transmits a BPPREQ message to the source eUICC 702 including the TSigned2, TSignature2, and SEPToken. In operation 725, the source eUICC 702 verifies the TSignature2, TSigned2, and the SEPToken authorizing the transfer. The source eUICC 702 may also verify the TCapabilities against the profile metadata and the TCA version to verify that the target device UE 115 capabilities are compatible with the profile. In some example embodiments, the source eUICC 702 may alter the profile based on the capabilities of the target device UE 115. The source eUICC 702 also generates an otPKSource (e.g., a one-time public key) and otSKSource (e.g., a one-time private key), and derives one or more session keys that are bound to the profile from the public key(s) generated by the target device UE 115 and the private keys generated by the source device UE 110.

In operation 726, the source eUICC 702 builds a BPP for the profile based on the TCapabilities. The source eUICC 702 then marks the profile with the state EXPORT PENDING. At this point in the call flow 700, the profile to be exported will still be on the source device UE 110 and may be enabled on the source device UE 110. As will be described in greater detail below, the profile will not be deleted from the source device UE 110 until there is confirmation that the target device UE 115 successfully imported the profile.

Referring back to the state diagram 300 of FIG. 3 for the profile on the source device UE 110, it can be seen that when the profile is marked as export pending, the profile transitions 305 from the disabled state 301 to the disabled export pending state 307 or transitions 306 from the enabled state 302 to the enabled export pending state 308. As also described above, when in either of the export pending states 307 or 308 on the source device UE 110, the profile may be transitioned 309 or 310 between the enabled 308 or disabled state 307.

Returning to the call flow 700, in 727, the source eUICC 702 transmits an ExportBPPRSP message to the Source AP 701 that including a status, e.g., allowing the Source AP 701 to understand when the BPP is ready for export. When the Source AP 701 understands the BPP is ready for export based on the status, in 728, the Source AP 701 sends a getBPPREQ message to the source eUICC 702. In operation 729, the source eUICC 702 verifies the BPP is marked Export Pending and in 730, the source eUICC 702 transmits the BPP to Source AP 701. The BPP may be a relatively large file and therefore the transfer in 730 may encompass multiple messages between the source eUICC 702 and the Source AP 701.

In 731, the Source AP 701 transmits a GetExportedBPPREQ to the Target AP 704 including the BPP. In 732, the Target AP 704 transmits a LoadBoundPorfilePackageREQ to the target eUICC 703 including the BPP. Again, the operations in 731 and 732 may include multiple message based on the size of the BPP.

In operation 733, the target eUICC 703 installs the profile on the target device UE 115 and generates a signed ImportReceipt that will be sent back to the source eUICC 702 as will be described in greater detail below. The target eUICC 703 will also mark the profile to the state IMPORTED.

Referring back to the state diagram 400 of FIG. 4 for the profile on the target device, it can be seen that a profile when initially imported is in imported state 401. The profile cannot be used by the target device UE 115 when in the imported state 401. Rather, as will be described in greater detail below, the profile will be approved by the source device 110 for use by the target device UE 115.

Returning to the call flow 700, in 734, the target eUICC 703 sends a LoadBoundProfilePackageRSP message to the Target AP 704 including the ImportReceipt. In 737, the Target AP 704 transits a HandleExportReceiptREQ message to the Source AP 701 including the ImportedReceipt. In 738, the Source AP 701 transmits a NotifyImportedProfileREQ to the source eUICC 702 including the ImportedReceipt.

In operation 739, the source eUICC 702 checks the ImportedReceipt signature and checks that the TID corresponds to the exported profile. If these checks are successful, the source device UE 110 will understand that the profile has been successfully installed on the target device UE 115. The source eUICC 702 may then disables the profile if it is still enabled (e.g., transition the profile on the source device UE 110 to the disabled export pending state 307 of FIG. 3 if the profile is not currently in that state.) The source eUICC 702 may then transition the profile to the state EXPORTED (e.g., transition 311 the profile from the disabled export pending state 307 to the exported state 313 of FIG. 3) and generates an exportedNotification in persistent memory.

The call flow 700 continues on FIG. 7C. In 740, the source eUICC 702 transmits a NotifyImportedProfileRSP message to the Source AP 701 including the exportedNotification. In 741, the Source AP 701 transmits a HandleExportReceiptRSP message to the Target AP 704 including the exportedNotification. In 742, the Target AP 704 transmits a ReceiptSentRSP message to the target eUICC 703 including the exportedNotification.

In operation 743, the target eUICC 703 deletes the import receipt, checks the signature, the TID and ICCID. At this point, the target device UE 115 understands that the profile has been released by the source device UE 110 allowing the target device UE 115 to transition the profile to the DISABLED state (e.g., transition 402 the profile from the imported state 401 to the disabled state 403 in FIG. 4). At this point, the profile may be enabled by the target device UE 115. For example, the target device UE 115 may prompt a user via a UI to enable the profile. This will cause the profile to transition 404 from the disabled state 403 to the enabled state 406 in FIG. 4. As also shown in FIG. 4, the profile may now be transitioned 404 and 405 between the enabled state 406 and the disabled state 403 on the target device UE 115. In addition to the above, in 743, the target eUICC 703 may also generate an installationReceipt.

In 744, the target eUICC 703 transmits a ReceiptSentRSP to the Target AP 704 including the installationReceipt. In 745, the Target AP 704 transmits a HandleInstallReceipt message to the Source AP 701 including the installationReceipt. In 746, the Source AP 701 transmits a NotifyInstallProfileREQ message to the source eUICC 702 including the installation receipt.

In operation 747, the source eUICC 702 clears the exported notification and cleans the session data. This may include deleting the profile from the source eUICC 702 which is shown in FIG. 3 as transitioning 314 the profile from the exported state 313 to the deleted state 315.

In 748, the source eUICC 702 transits an OK message (e.g., an ACK) to the Source AP 701. In 749, the Source AP 701 transmits an OK message to the Target AP 704 indicating that the transfer is complete.

### EXAMPLES

In a first example, a method performed by a first user equipment (UE), comprising receiving, from a second UE, a request to export a selected embedded subscriber identity module (e-SIM) profile, the request comprising an integrated circuit card identification (ICCID) corresponding to the selected e-SIM profile and a target cryptographic token corresponding to the ICCID, determining the e-SIM profile corresponding to the ICCID is stored on the first UE and is eligible for export, generating a transaction identification (TID) corresponding to the ICCID and a source cryptographic token corresponding to the ICCID, generating a source encrypted signature comprising the ICCID, the TID, the source cryptographic token and the target cryptographic token and transmitting the source encrypted signature to the second UE.

In a second example, the method of the first example, further comprising receiving, from the second UE, a target encrypted signature comprising the ICCID, the TID and the source cryptographic token and verifying the target encrypted signature.

In a third example, the method of the second example, further comprising exporting the selected eSIM profile to the second UE.

In a fourth example, the method of the third example, wherein the exporting of the selected eSIM comprises generating a bound profile package (BPP) associated with the selected e-SIM profile and marking the selected e-SIM profile as export pending.

In a fifth example, the method of the fourth example, further comprising receiving an import receipt from the second UE, verifying the import receipt corresponds to the selected e-SIM profile and marking the selected e-SIM profile as exported.

In a sixth example, the method of the second example, further comprising performing a secure intent verification comprising receiving user input verifying a user intent to export the selected eSIM profile.

In a seventh example, the method of the sixth example, Wherein successful completion of the secure intent verification results in generating a signed token comprising the ICCID, the TID and an Embedded Identity Document (EID) of an embedded universal integrated circuit card (eUICC) of the second UE.

In an eighth example, the method of the seventh example, wherein the exporting of the selected eSIM profile comprises verifying the signed token.

In a ninth example, the method of the first example, wherein the request further comprises information related to an embedded universal integrated circuit card (eUICC), the method further comprising determining the information related to the eUICC comprises a cryptographic key associated with the selected e-SIM profile.

In a tenth example, the method of the first example, wherein the source encrypted signature further comprises information related to a key to decrypt the source encrypted signature.

In an eleventh example, the method of the first example, wherein the target encrypted signature further comprises information related to a capability of the second UE.

In a twelfth example, the method of the eleventh example, further comprising altering the selected eSIM profile based on the capability of the second UE.

In a thirteenth example, a processor configured to perform any of the methods of the first through twelfth examples.

In a fourteenth example, a user equipment (UE) comprising transceiver circuitry configured to communicate with a network and a processor communicatively coupled to the transceiver circuitry and configured to perform any of the methods of the first through twelfth examples.

In a fifteenth example, a method performed by a first user equipment (UE), comprising sending, to a second UE, a request to export a selected embedded subscriber identity module (e-SIM) profile, the request comprising an integrated circuit card identification (ICCID) corresponding to the selected e-SIM profile and a target cryptographic token corresponding to the ICCID, receiving, from the second UE, a source encrypted signature comprising the ICCID, a transaction identification (TID) corresponding to the ICCID, a source cryptographic token corresponding to the ICCID and the target cryptographic token, verifying the source encrypted signature based on at least the ICCID and the target cryptographic token, generating a target encrypted signature comprising the ICCID, the TID, and the source cryptographic token and transmitting the target encrypted signature to the second UE.

In a sixteenth example, the method of the fifteenth example, further comprising importing the selected eSIM profile from the second UE.

In a seventeenth example, the method of the fifteenth example, wherein the importing the selected eSIM profile comprises installing the selected e-SIM profile on an embedded universal integrated circuit card (eUICC) of the second UE, generating an import receipt for the selected e-SIM profile, marking the selected e-SIM profile as imported and sending the import receipt to the second UE.

In an eighteenth example, the method of the fifteenth example, further comprising displaying on a user interface (UI) of the first UE, one or more eSIM profiles and receiving, on the UI, user input of the selected eSIM profile.

In a nineteenth example, the method of the fifteenth example, wherein the request further comprises information related to an embedded universal integrated circuit card (eUICC), wherein the information comprises a cryptographic key associated with the selected e-SIM profile.

In a twentieth example, the method of the fifteenth example, wherein the source encrypted signature further comprises information related to a key to decrypt the source encrypted signature, the method comprising decrypting the source encrypted signature based on at least the key.

In a twenty first example, the method of the fifteenth example, further comprising storing the TID in session data.

In a twenty second example, the method of the fifteenth example, wherein the target encrypted signature further comprises a one-time target public key for decrypting the target encrypted signature.

In a twenty third example, the method of the fifteenth example, wherein the target encrypted signature further comprises information related to a capability of the first UE.

In a twenty fourth example, a processor configured to perform any of the methods of the fifteenth through twenty third examples.

In a twenty fifth example, a user equipment (UE) comprising transceiver circuitry configured to communicate with a network and a processor communicatively coupled to the transceiver circuitry and configured to perform any of the methods of the fifteenth through twenty third examples.

In a twenty sixth example, a method performed by a first user equipment (UE), comprising receiving, from a second UE, a request to export a selected embedded subscriber identity module (e-SIM) profile, the request comprising an integrated circuit card identification (ICCID) corresponding to the selected e-SIM profile, determining the e-SIM profile corresponding to the ICCID is stored on the first UE and is eligible for export, generating a source cryptographic token corresponding to the ICCID, transmitting, to the second UE, a message comprising the source cryptographic token, receiving, from the second UE, a target encrypted signature comprising the ICCID, the source cryptographic token and a target cryptographic token corresponding to the ICCID and verifying the target encrypted signature based on at least the ICCID and the source cryptographic token.

In a twenty seventh example, the method of the twenty sixth example, further comprising generating a transaction identification (TID) corresponding to the ICCID, generating a source encrypted signature comprising the ICCID, the TID, and the source cryptographic token and transmitting the source encrypted signature to the second UE.

In a twenty eighth example, the method of the twenty seventh example, further comprising exporting the eSIM profile to the second UE.

In a twenty ninth example, the method of the twenty eighth example, wherein the exporting of the selected eSIM comprises generating a bound profile package (BPP) associated with the selected e-SIM profile and marking the selected e-SIM profile as export pending.

In a thirtieth example, the method of the twenty ninth example, further comprising receiving an import receipt from the second UE, verifying the import receipt corresponds to the selected e-SIM profile and marking the selected e-SIM profile as exported.

In a thirty first example, the method of the twenty seventh example, further comprising performing a secure intent verification comprising receiving user input verifying a user intent to export the selected eSIM profile.

In a thirty second example, the method of the thirty first example, wherein successful completion of the secure intent verification results in generating a signed token comprising the ICCID, the TID and an Embedded Identity Document (EID) of an embedded universal integrated circuit card (eUICC) of the second UE.

In a thirty third example, the method of the thirty second example, wherein the exporting of the selected eSIM profile comprises verifying the signed token.

In a thirty fourth example, a processor configured to perform any of the methods of the twenty sixth through thirty third examples.

In a thirty fifth example, a user equipment (UE) comprising transceiver circuitry configured to communicate with a network and a processor communicatively coupled to the transceiver circuitry and configured to perform any of the methods of the twenty sixth through thirty third examples.

In a thirty sixth example, a method performed by a first user equipment (UE), comprising sending, to a second UE, a request to export a selected embedded subscriber identity module (e-SIM) profile, the request comprising an integrated circuit card identification (ICCID) corresponding to the selected e-SIM profile, receiving, from the second UE, a message comprising a source cryptographic token, generating a target cryptographic token corresponding to the ICCID, generating a target encrypted signature comprising the ICCID, the source cryptographic token and the target cryptographic token and sending the target encrypted signature to the second UE.

In a thirty seventh example, the method of the thirty sixth example, further comprising receiving, from the second UE, a source encrypted signature comprising the ICCID, the target cryptographic token and a transaction identification (TID) corresponding to the ICCID and verifying the source encrypted signature based on at least the ICCID and the target cryptographic token.

In a thirty eighth example, the method of the thirty seventh example, further comprising importing the eSIM profile from the second UE.

In a thirty ninth example, a processor configured to perform any of the methods of the thirty sixth through thirty eighth examples.

In a fortieth example, a user equipment (UE) comprising transceiver circuitry configured to communicate with a network and a processor communicatively coupled to the transceiver circuitry and configured to perform any of the methods of the thirty sixth through thirty eighth examples.

In a forty first example, a method performed by an embedded universal integrated circuit card (eUICC) of a user equipment (UE), comprising receiving, from an extended storage component of the UE, a request to export a selected embedded subscriber identity module (e-SIM) profile, the request comprising an integrated circuit card identification (ICCID) corresponding to the selected e-SIM profile, determining the e-SIM profile corresponding to the ICCID is stored on the eUICC, the e-SIM profile is eligible for export and the e-SIM profile is disabled, generating a transaction identification (TID) corresponding to the ICCID, generating a bound profile package (BPP) associated with the selected e-SIM profile and exporting the BPP associated with the selected e-SIM profile to the extended storage component.

In a forty second example, the method of the forty first example, further comprising receiving, from the extended storage component, the BPP associated with the selected e-SIM profile, determining the TID in the BPP corresponds to the selected e-SIM profile, determining the selected e-SIM profile status is set to extended storage and reinstalling the selected e-SIM profile on the eUICC.

In a forty third example, the method of the forty second example, further comprising deleting the TID.

In a forty fourth example, the method of the forty second example, further comprising generating an installation receipt based on the selected e-SIM profile being successfully reinstalled on the eUICC and sending the installation receipt to the extended storage component.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a user equipment (UE), a request to export an embedded subscriber identity module (e-SIM) profile, the request comprising an integrated circuit card identification (ICCID) corresponding to the e-SIM profile and a target cryptographic token corresponding to the ICCID;
determine the e-SIM profile corresponding to the ICCID is stored on the apparatus and is eligible for export;
generate a transaction identification (TID) corresponding to the ICCID and a source cryptographic token corresponding to the ICCID; and
generate, for transmission to the UE, a source encrypted signature comprising the ICCID, the TID, the source cryptographic token and the target cryptographic token.

2. The apparatus of claim 1, wherein the processing circuitry is further configured to:
process, based on signals received from the UE, a target encrypted signature comprising the ICCID, the TID and the source cryptographic token; and
verify the target encrypted signature.

3. The apparatus of claim 2, wherein the processing circuitry is further configured to:
export the eSIM profile to the UE.

4. The apparatus of claim 3, wherein, exporting the eSIM profile, is based on the processing circuitry being configured to:
generate a bound profile package (BPP) associated with the selected e-SIM profile; and
mark the selected e-SIM profile as export pending.

5. The apparatus of claim 4, wherein the processing circuitry is further configured to:
receive an import receipt from the UE;
verify the import receipt corresponds to the selected e-SIM profile; and
mark the selected e-SIM profile as exported.

6. The apparatus of claim 2, wherein the processing circuitry is further configured to:
perform a secure intent verification comprising receiving user input verifying a user intent to export the eSIM profile.

7. The apparatus of claim 6, wherein successful completion of the secure intent verification results in generating a signed token comprising the ICCID, the TID and an Embedded Identity Document (EID) of an embedded universal integrated circuit card (eUICC) of the UE.

8. The apparatus of claim 1, wherein the request further comprises information related to an embedded universal integrated circuit card (eUICC), wherein the processing circuitry is further configured to:
determine the information related to the eUICC comprises a cryptographic key associated with the selected e-SIM profile.

9. An apparatus comprising processing circuitry configured to:
generate, for transmission to a user equipment (UE), a request to export an embedded subscriber identity module (e-SIM) profile, the request comprising an integrated circuit card identification (ICCID) corresponding to the e-SIM profile and a target cryptographic token corresponding to the ICCID;
process, based on signals received from the UE, a source encrypted signature comprising the ICCID, a transaction identification (TID) corresponding to the ICCID, a source cryptographic token corresponding to the ICCID and the target cryptographic token;
verify the source encrypted signature based on at least the ICCID and the target cryptographic token; and
generate, for transmission to the UE, a target encrypted signature comprising the ICCID, the TID, and the source cryptographic token.

10. The apparatus of claim 9, wherein the processing circuitry is further configured to:
import the eSIM profile from the UE.

11. The apparatus of claim 10, wherein importing the eSIM profile is based on the processing circuitry being configured to:
install the selected e-SIM profile on an embedded universal integrated circuit card (eUICC) of the apparatus;
generate an import receipt for the selected e-SIM profile;
mark the selected e-SIM profile as imported; and
generate, for transmission to the UE, a message comprising the import receipt.

12. The apparatus of claim 9, wherein the processing circuitry is further configured to:
generate, for display on a user interface (UI) of the apparatus, one or more eSIM profiles; and
process, based on user input on the UI, the eSIM profile.

13. The apparatus of claim 9, wherein the request further comprises information related to an embedded universal integrated circuit card (eUICC), wherein the information comprises a cryptographic key associated with the selected e-SIM profile.

14. The apparatus of claim 9, wherein the source encrypted signature further comprises information related to a key to decrypt the source encrypted signature, wherein the processing circuitry is further configured to:
decrypt the source encrypted signature based on at least the key.

15. The apparatus of claim 9, wherein the target encrypted signature further comprises a one-time target public key to decrypt the target encrypted signature.

16. The apparatus of claim 9, wherein the target encrypted signature further comprises information related to a capability of the apparatus.

17. An apparatus comprising processing circuitry configured to:
process, based on signals received from a user equipment (UE), a request to export an embedded subscriber identity module (e-SIM) profile, the request comprising an integrated circuit card identification (ICCID) corresponding to the e-SIM profile;
determine the e-SIM profile corresponding to the ICCID is stored on the apparatus and is eligible for export;
generate a source cryptographic token corresponding to the ICCID;
generate, for transmission to the UE, a message comprising the source cryptographic token;
process, based on signals received from the UE, a target encrypted signature comprising the ICCID, the source cryptographic token and a target cryptographic token corresponding to the ICCID; and
verify the target encrypted signature based on at least the ICCID and the source cryptographic token.

18. The apparatus of claim 17, wherein the processing circuitry is further configured to:
generate a transaction identification (TID) corresponding to the ICCID; and
generate, for transmission to the UE, a source encrypted signature comprising the ICCID, the TID, and the source cryptographic token.

19. The apparatus of claim 17, wherein the processing circuitry is further configured to:
export the eSIM profile to the UE, wherein the exporting the eSIM profile is based on the processing circuitry being configured to:
generate a bound profile package (BPP) associated with the selected e-SIM profile; and
mark the selected e-SIM profile as export pending.

20. The apparatus of claim 17, wherein the processing circuitry is further configured to:
process, based on signals received from the UE, an import receipt from the UE;
verify the import receipt corresponds to the selected e-SIM profile; and
mark the selected e-SIM profile as exported.
